(19) United States
(12) Patent Application Publication
(10) Pub. No.: US 2016/0069448 A1
(43) Pub. Date: Mar. 10, 2016

(54) Automatic Transmission Device

(71) Applicant: Thurman Tyus, II, Cleveland, OH (US)

(72) Inventor: Thurman Tyus, II, Cleveland, OH (US)

(21) Appl. No.: 14/847,201

(22) Filed: Sep. 8, 2015

Related U.S. Application Data
(60) Provisional application No. 62/047,067, filed on Sep. 8, 2014.

(51) Int. Cl. F16H 57/04; F16H 48/38; F16H 57/00

(52) U.S. Cl. CPC F16H 57/0483; F16H 57/0018; F16H 48/38

(57) ABSTRACT

1. An automatic transmission device comprises a hardened, solid steel round bar for placing inside the differential housing, six evenly spaced grooves, the device configured so that six evenly space grooves provide constant lubrication to the rotating spider gears.

The present invention relates to an automatic transmission device.

### BACKGROUND

The spider gears seizes the differential shaft pin on the A604 (41TE) automatic transmission and flings it through the aluminum transmission case while driving.

Prior art in the form of thin metal retainers placed on both sides of the shaft pin to stop the pin from damaging the case does not work, Pins have pushed past the metal retainers.

Presently, there is no solution for addressing this problem.

### SUMMARY

The present invention seeks to provide a solution to this problem by providing an automatic transmission device comprising a round shaft pin for placing through the spider gears; six oil lube channels, the device configured so that the six lube channels are for constant gear oil lubrication.

When the automatic transmission device is inserted into the differential and through the spider gears, the automatic transmission device provides constant lubrication of the spider gears.

Also, because of the lube channels, the spider gears when rotating have to rotate over the lube channel gaps, This creates less contact surface area and aids in preventing the spider gears from seizing the automatic transmission device.

The present invention will now be more particularly described with reference to the accompanying drawings, by way of example only and in on way limiting the scope of the invention, in which:

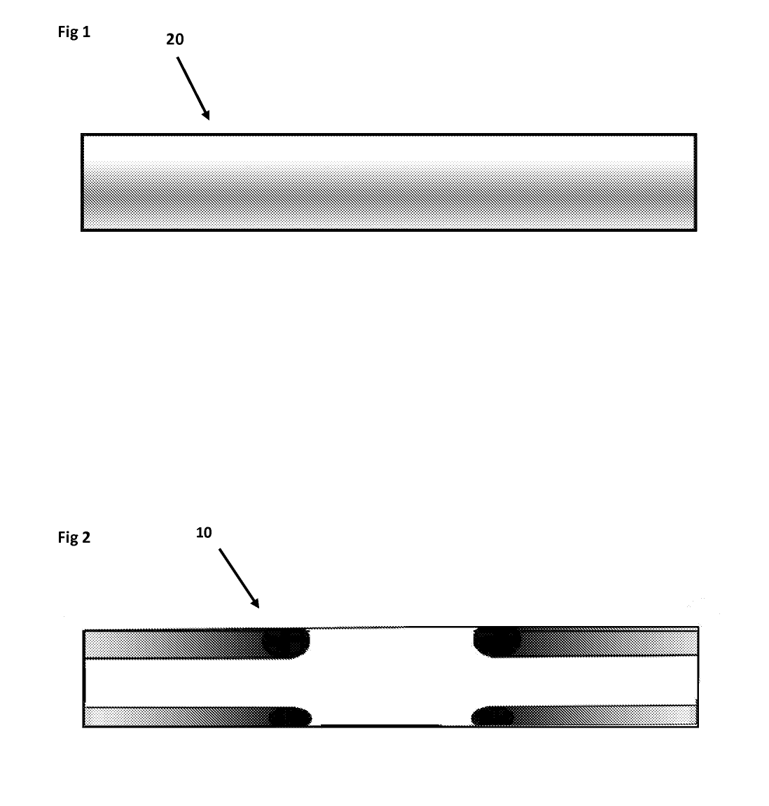

FIG. 1 is a top view of the prior art, a solid, round shaft pin with no oil channels.

FIG. 2 is a top view of the automatic transmission device with oil channels.

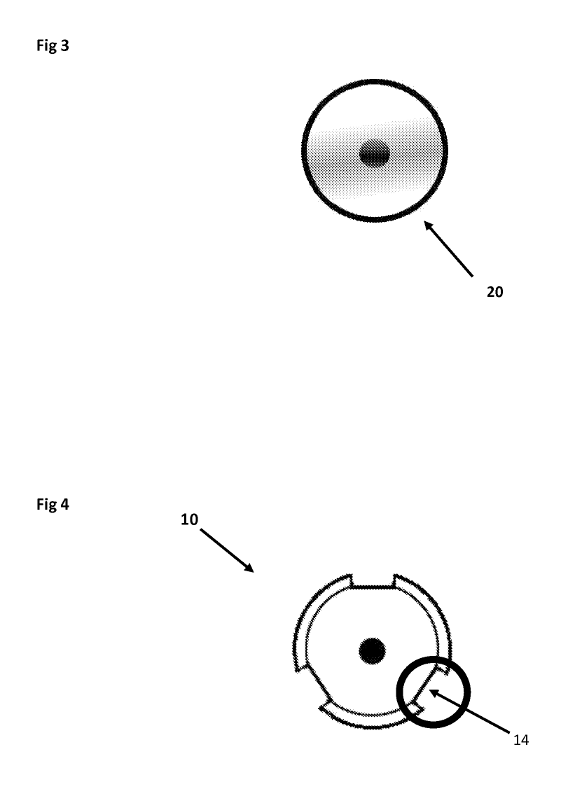

FIG. 3 is a front view of the prior art with no lube channels.

FIG. 4 is a front view of the automatic transmission device with oil channels.

FIG. 5 is the view of a spider gear.

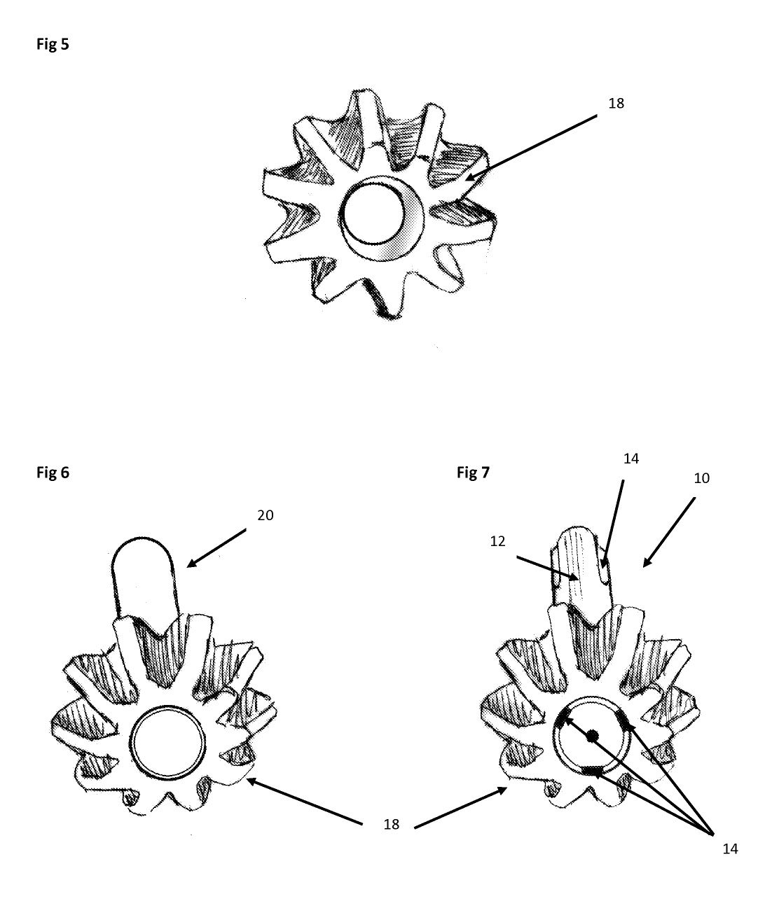

FIG. 6 shows the spider gear on the prior art shaft pin.

FIG. 7 shows the spider gear on the automatic transmission device.

FIG. 8 shows the differential with the automatic transmission device.

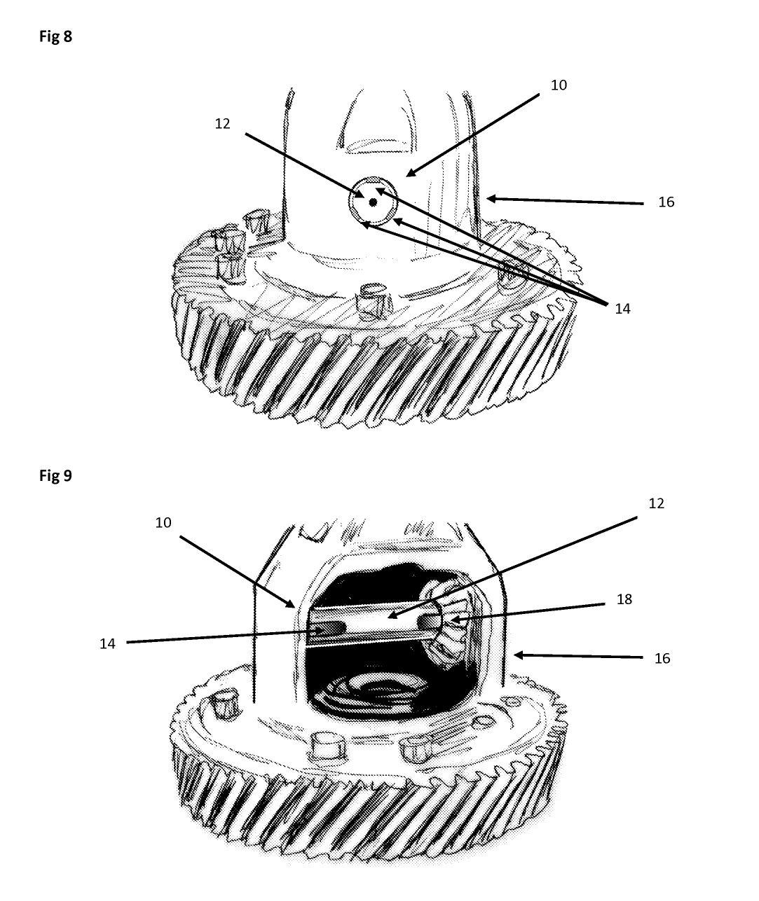

FIG. 9 shows the differential, the automatic transmission device and the spider gears.

### DETAILED DESCRIPTION

Referring to the drawings, an automatic transmission device 10 comprising: a solid steel bar 12 with six evenly spaced grooves 14 for placing inside the differential housing 16 and through the spider gears 18 the device configured so that six of the grooves 14 are for constant spider gear lubrication.

The solid steel bar 12 is made from preferably 9cr18 steel hardened to 52 rockwell, Although, the solid steel bar 12 can be made from various other qualified metals. In addition, the shape of the automatic transmission device 10 is preferably round to fit the hole in the differential housing 16 and the hole in the spider gear 18. The diameter of the automatic transmission device 10 is preferably 16.83 mm. However, it is possible to have a plus or minus variation in thickness between vehicle applications. The length of the automatic transmission device 10 is preferably 109.30 mm. The oil grooves 14 are evenly spaced around the automatic transmission device 10. The oil grooves 14 are preferably 39.25 mm long from end of automatic transmission device 10, Also, the oil grooves 14 are preferably 5.50 mm wide with a 0.70 mm deep channel.

The automatic transmission device 10 is made of harden steel to support spider gear 18 rotation.

FIG. 6 shows spider gear 18 on prior art shaft pin 20.

FIG. 7 shows spider gear 18 on automatic transmission device.

FIG. 9 gives clear picture of position of automatic transmission device 10 situated within differential housing 16 and spider gears 18.

Preferably, the automatic transmission device 10 is made from 9cr18 steel although it may be made from other suitable metals.

Preferably, the automatic transmission device 10 is used as an aid for preventing the seizing of the spider gears 18.

In use, an A604 (41TE) automatic transmission is brought into a transmission repair shop. Upon disassembly, it is discovered that the spider gears have seized the differential shaft pin and has flung the pin into the transmission case, cracking the case. The user buys another transmission case and differential assembly for $200. The user assembles the various good parts into the good case, However, before placing the differential assembly into the good case, the user replaces the prior art shaft pin with the automatic transmission device. As a result of the automatic transmission device, the spider gears get constant oil lubrication resulting in aiding against seizing of the differential shaft pin, the automatic transmission device, and cracking the new transmission case.

The embodiments described above are provided by way of example only and various other modifications will be apparent to persons skilled in the art without departing from the scope of the invention as defined in the appended claims.

1. An automatic transmission device comprising:
a hardened solid steel round bar for placing inside the differential housing; six evenly spaced grooves. The device configure so that six evenly spaced grooves provide constant lubrication to the rotating spider gears.
